(19) United States
(12) Patent Application Publication
(10) Pub. No.: US 2024/0286754 A1
(43) Pub. Date: Aug. 29, 2024

(54) FUEL TANK INERTING SYSTEM

(71) Applicant: General Electric Company, Schenectady, NY (US)

(72) Inventors: Honggang Wang, Clifton Park, NY (US); Brandon Wayne Miller, Liberty Township, OH (US); Michael Anthony Benjamin, Cincinnati, OH (US); Richard L. Hart, Broadalbin, NY (US); Randy M. Vondrell, Newport, KY (US); Ryan St. Pierre, Jacksonville, FL (US)

(21) Appl. No.: 18/404,258

(22) Filed: Jan. 4, 2024

(30) Foreign Application Priority Data
Feb. 23, 2023 (CN) 202310155637.7

(51) Int. Cl. B64D 37/32; B64D 27/355

(52) U.S. Cl. CPC B64D 37/32; B64D 27/355

(57) ABSTRACT

A system for an aircraft including: a fuel tank defining an interior; and a fuel cell assembly having a fuel cell defining an air outlet, wherein the air outlet of the fuel cell is in airflow communication with the interior of the fuel tank for providing an inerting airflow from the fuel cell to the interior of the fuel tank to reduce an oxygen content of the interior of the fuel tank.

### FIELD

The present application claims priority to Chinese Patent Application Serial Number 202310155637.7 filed on Feb. 23, 2023.

### FIELD

The present disclosure relates to a fuel tank inerting system for an aircraft.

### BACKGROUND

Aircraft fuel tanks generally include a fuel portion containing liquid fuel and an ullage portion containing a mixture of air and fuel vapor. It is generally desirable to reduce a content of fuel vapor in the ullage portion. Various inerting technologies have been employed to reduce the content of fuel vapor in the ullage portion. As examples, inerting techniques may include in-flight purging of fuel vapor from tanks and condensing the purged vapor to reduce the fuel to air ratio, or in-flight generation of inerting gas such as nitrogen or CO₂ and injection of the inert gas into the fuels tanks to reduce oxygen concentration. Each of these examples requires an energy input. Improvements to these systems would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a top view of an aircraft in accordance with an exemplary embodiment of the present disclosure.

FIG. 2 is a schematic diagram of an environmental control system assembly in accordance with an exemplary embodiment of the present disclosure.

FIG. 3 is a perspective view of a fuel cell stack of a fuel cell assembly of the exemplary environmental control system assembly of FIG. 2.

FIG. 4 is a schematic view of a fuel cell of the exemplary fuel cell stack of FIG. 3.

FIG. 5 is a schematic view of a controller in accordance with an exemplary embodiment of the present disclosure.

FIG. 6 is a cross-sectional view of a gas turbine engine in accordance with an exemplary aspect of the present disclosure.

FIG. 7 is a schematic view of a fuel cell inerting system in accordance with an exemplary embodiment of the present disclosure.

FIG. 8 is a flow diagram of a method for operating a fuel cell inerting system in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” or “at least one of A, B, or C” refers to only A, only B, only C, or any combination of A, B, and C.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes. Each of these fuel cells may have specific benefits in the form of a preferred operating temperature range, power generation capability, efficiency, etc.

In particular, it will be appreciated that a SOFC is generally an electrochemical conversion device that produces electricity directly from oxidizing a fuel. The SOFC's of the present disclosure may generally include a solid oxide or ceramic electrolyte. This class of fuel cells generally exhibit high combined heat and power efficiency, long-term stability, fuel flexibility, and low emissions.

As used herein, the term “inerting airflow,” with respect to a volume set to receive the inerting airflow (e.g., a fuel tank ullage) refers to an airflow having an oxygen content less than what an oxygen content of an air within the volume would be absent receiving the inerting airflow (e.g., a steady state oxygen content). For example, with respect to an inerting system for a fuel tank, the term “inerting airflow” from the inerting system refers to an airflow having an oxygen content less than what an oxygen content of an air within the fuel tank would be without the inerting system. In certain exemplary aspects, the term “inerting airflow” may refer to an airflow having less than 12% oxygen content by weight.

A fuel tank inerting system is provided that utilizes an air output from a fuel cell as an inerting gas for a fuel tank. In certain embodiments, the fuel cell may be controlled to prioritize the air output being below a predetermined threshold so as to effectively act as the inerting gas for the fuel tank. The air output of the fuel cell may be sufficiently low in oxygen content such that during typical operations the air output is below the predetermined threshold. This may allow for the fuel cell to generate the inerting gas with little or no additional energy input for the system. Such a configuration may also allow for a reduction in a size of an existing fuel tank inerting system, or alternatively removal of another fuel tank inerting system, resulting in an overall more efficient aircraft.

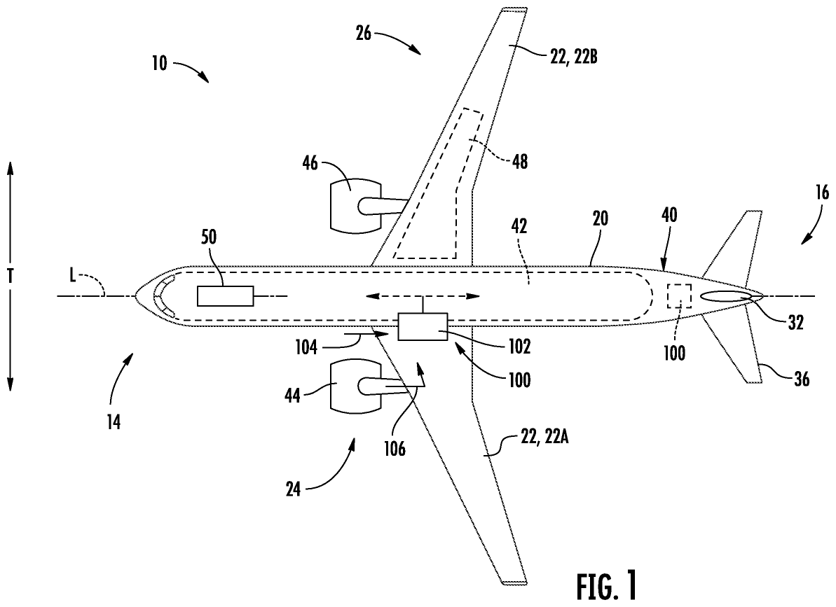

Referring now to the drawings, wherein identical numerals indicate the same elements throughout the FIGS., FIG. 1 provides a top view of an exemplary aircraft 10 as may incorporate various embodiments of the present disclosure. As shown in FIG. 1, the aircraft 10 defines a longitudinal direction L that extends therethrough, a transverse direction T, a forward end 14, and an aft end 16.

Moreover, the aircraft 10 includes a fuselage 20, extending longitudinally from the forward end 14 of the aircraft 10 towards the aft end 16 of the aircraft 10, and a pair of wings 22, or rather, a first wing 22A and a second wing 22B. The first wing 22A extends outwardly from the fuselage 20 generally along the transverse direction T with respect to the longitudinal direction L, from a port side 24 of the fuselage 20. Further, the second wing 22B similarly extends outwardly from the fuselage 20, generally along the transverse direction T with respect to the longitudinal direction L, from a starboard side 26 of the fuselage 20. In addition, the aircraft 10 further includes a vertical stabilizer 32 and a pair of horizontal stabilizers 36. The fuselage 20 additionally includes an outer surface 40 and defines a cabin 42 inward of the outer surface 40 of the fuselage 20 (depicted in phantom in FIG. 1). The cabin 42 generally refers to an area to be occupied by one or more passengers, crew, or both during a flight operation of the aircraft 10. The fuselage 20, wings 22, and stabilizers 32, 36 may together be referred to as a body of the aircraft 10.

However, it should be appreciated that in other exemplary embodiments of the present disclosure, the aircraft 10 may additionally or alternatively include any other suitable configuration of, e.g., stabilizers that may or may not extend directly along a vertical direction or horizontal/transverse direction T, wings 22, etc.

The exemplary aircraft 10 of FIG. 1 also includes a propulsion system. The exemplary propulsion system depicted includes a plurality of aircraft engines, at least one of which is mounted to each of the pair of wings 22A, 22B. Specifically, the plurality of aircraft engines includes a first aircraft engine 44 mounted to the first wing 22A and a second aircraft engine 46 mounted to the second wing 22B. In at least certain exemplary embodiments, the aircraft engines 44, 46 may be configured as turbofan jet engines suspended beneath the wings 22A, 22B in an under-wing configuration.

Alternatively, however, in other exemplary embodiments any other suitable aircraft engine may be provided. For example, in other exemplary embodiments the first and/or second aircraft engines 44, 46 may alternatively be configured as turbojet engines, turboshaft engines, turboprop engines, etc. Further, in still other exemplary embodiments, the propulsion system may additionally or alternatively include one or more electric, or hybrid-electric, aircraft engines (e.g., electric fans).

The aircraft 10 may further include one or more fuel tanks 48. In at least certain exemplary aspects, as is depicted in phantom in FIG. 1, the one or more fuel tanks 48 of the aircraft 10 may be housed within the wings 22A, 22B of the aircraft 10 (depicted in phantom only in second wing 22B for clarity). The one or more fuel tanks 48 may provide fuel to the aircraft engines 44, 46 of the propulsion system of the aircraft 10.

Moreover, it will be appreciated that the exemplary aircraft 10 of FIG. 1 further includes an environmental control system assembly 100 (or “ECS assembly 100”) having an environmental control system 102 (or “ECS 102”). The ECS 102 may generally be configured to receive an airflow, such as an ambient airflow or ram airflow 104 from a ram air inlet, a bleed airflow 106 from one or both of the aircraft engines 44, 46, or both. The ECS 102 is further configured to condition such airflow and provide such airflow to the cabin 42 to assist with pressurizing the cabin 42 and providing thermal control of the cabin 42, and optionally to provide cooling for accessory systems, such as avionics.

Notably, for the embodiment depicted, the ECS assembly 100 is located generally at a juncture between the first wing 22A and the fuselage 20. However, in other exemplary embodiments, the ECS assembly 100 may additionally or alternatively be located at any other suitable location within the aircraft 10. For example, in other exemplary embodiments, the ECS assembly 100 may be located at a juncture between the second wing 22B and the fuselage 20, or alternatively, as depicted in phantom, at the aft end 16 of the aircraft 10.

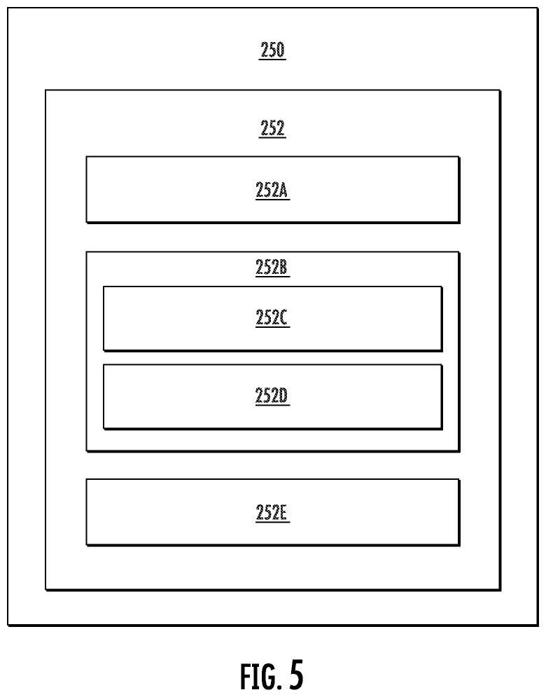

Briefly, it will further be appreciated that the aircraft 10 includes an aircraft controller 50. The aircraft controller 50 may be operably coupled to one or more outside data sources for receiving data from such outside data sources relating to, e.g., a passenger number (or passenger count) for a particular flight operation, weather data for the flight operation, flight data, etc. The aircraft controller 50 may include a similar structure as the controller 250 of the ECS assembly 100 described below with reference to FIG. 5.

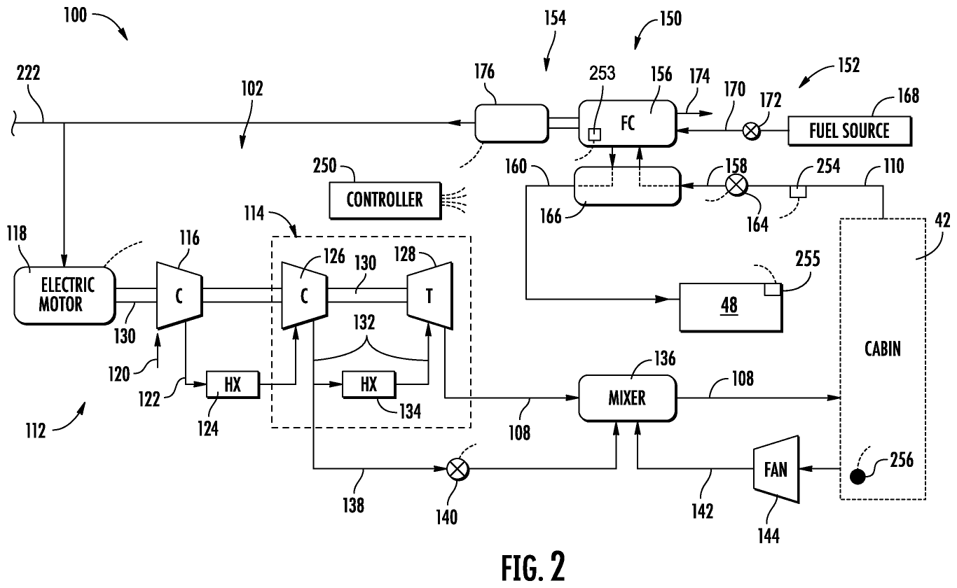

Referring now to FIG. 2, a schematic diagram is provided of the exemplary ECS assembly 100 introduced above with reference to FIG. 1. As will be appreciated, the exemplary ECS assembly 100 is operable with the cabin 42 of the aircraft 10 to, e.g., provide cooling air to the cabin 42.

As will be appreciated, the ECS assembly 100 generally includes the ECS 102 for generating a cabin inlet airflow, a cabin airflow delivery system 108 in airflow communication with the ECS 102 for receiving the cabin inlet airflow from the ECS 102 and providing the cabin inlet airflow to the cabin 42, and a cabin exhaust delivery system 110 in airflow communication with the cabin 42 for receiving a cabin exhaust airflow from the cabin 42.

The ECS 102 generally includes a compressed airflow source 112 and an air cycle machine 114 (enclosed by phantom lines in FIG. 2). In the embodiment shown, the compressed airflow source 112 includes an initial compressor 116 and an electric motor 118 drivingly coupled to the initial compressor 116 and the air cycle machine 114. The initial compressor 116 is in airflow communication with an ECS inlet 120 configured to receive an ECS inlet airflow, which may be, e.g., an ambient airflow from a ram air inlet (see, e.g., ram airflow 104 of FIG. 1). The initial compressor 116 is configured to compress the ECS inlet airflow received from the ECS inlet 120, referred to below as simply an ECS airflow. The compressed ECS airflow is then provided to the air cycle machine 114 through a first duct 122. As will be appreciated, during certain flight operations, the ECS airflow may be relatively cool. While compressing the ECS airflow through the initial compressor 116 may increase a temperature of the ECS airflow, the ECS 102 further includes a first heat exchanger 124 in thermal communication with the first duct 122 for adding heat to the compressed ECS airflow through the first duct 122.

Briefly, it will be appreciated that the compressed airflow source 112 may be any other suitable source of compressed airflow. For example, in other embodiments, the compressed airflow source 112 may be a bleed airflow source configured to received bleed airflow from an engine of the aircraft (e.g., bleed airflow 106 depicted in FIG. 1). With such a configuration, the compressed airflow source 112 may include a pressure reducer to reduce a pressure of the bleed airflow and, optionally, a heat exchanger to modify a temperature of the bleed airflow provided to the air cycle machine 114 such that it is within an acceptable temperature range. In such a manner, the compressed airflow source 112 may generally be referred to as an airflow conditioner, as it may be configured to provide compressed airflow within the acceptable pressure (and optionally temperature) range to the air cycle machine 114.

Referring still to FIG. 2, the air cycle machine 114 includes an air cycle machine compressor 126 and an air cycle machine turbine 128. Notably, for the embodiment shown, the initial compressor 116, the air cycle machine compressor 126, and the air cycle machine turbine 128 are each coupled to a common ECS shaft 130, with the ECS shaft 130 rotatable with, and more specifically rotatably driven by, the electric motor 118. The air cycle machine compressor 126 is in airflow communication with the first duct 122 for receiving the compressed ECS airflow, and is configured to further compress the ECS airflow and provide such ECS airflow to the air cycle machine turbine 128 through a second duct 132 of the ECS 102.

As will further be appreciated from FIG. 2, the exemplary ECS 102 depicted further includes a second heat exchanger 134 in thermal communication with the second duct 132 for adding additional heat to the ECS airflow downstream of the air cycle machine compressor 126 and upstream of the air cycle machine turbine 128.

The air cycle machine turbine 128 is in airflow communication with the second duct 132 for receiving the ECS airflow and expanding the ECS airflow, reducing a pressure and a temperature of the ECS airflow. The air cycle machine turbine 128 is in airflow communication with the cabin airflow delivery system 108 for providing the expanded ECS airflow to the cabin airflow delivery system 108 as a cabin inlet airflow.

In the exemplary embodiment depicted, the ECS assembly 100, or rather, the cabin airflow delivery system 108, includes a mixer 136 and the ECS 102 further includes an air cycle machine turbine bypass duct 138 extending from the air cycle machine compressor 126 to the mixer 136, bypassing the air cycle machine turbine 128 and, for the embodiment shown, the second heat exchanger 134. The mixer 136 is configured to receive airflow from the air cycle machine turbine bypass duct 138 and incorporate such airflow into the cabin inlet airflow.

A turbine bypass valve 140 is in airflow communication with the air cycle machine turbine bypass duct 138 for modulating an airflow therethrough. As will be appreciated, by modulating the amount of airflow through the air cycle machine turbine bypass duct 138, temperature and pressure regulation of the cabin inlet airflow may be accomplished. For example, as will be appreciated, the airflow through the air cycle machine turbine bypass duct 138 may be at a higher pressure and temperature than the airflow provided from the air cycle machine turbine 128 to the cabin airflow delivery system 108.

In addition, for the embodiment shown, it will be appreciated that the ECS assembly 100 further includes a recirculation airflow path 142 and a recirculation fan 144 (or recirculation compressor). The recirculation airflow path 142 is in airflow communication with cabin 42 for receiving a portion of the cabin exhaust airflow and further is in airflow communication with the mixer 136 for providing the portion of the cabin exhaust airflow to the mixer 136. The recirculation fan 144 is configured to increase a pressure of the portion of the cabin exhaust airflow prior to the portion of the cabin exhaust airflow reaching the mixer 136. The mixer 136 may further be configured to incorporate the portion of the cabin exhaust airflow through the recirculation airflow path 142 back into the cabin inlet airflow prior to the cabin airflow delivery system 108 providing such cabin inlet airflow to the cabin 42.

Referring still to FIG. 2, it will be appreciated that the ECS assembly 100 further includes the cabin exhaust delivery system 110 and a fuel cell assembly 150. The cabin exhaust delivery system 110 is in airflow communication with the cabin 42 of the aircraft 10 for receiving all or a portion of the cabin exhaust airflow and is further in airflow communication with the fuel cell assembly 150 for providing all or the portion of the cabin exhaust airflow from the cabin exhaust delivery system 110 to the fuel cell assembly 150.

In particular, it will be appreciated that the fuel cell assembly 150 generally includes a fuel delivery system 152, an air delivery system (which includes, for the embodiment depicted, a portion of the cabin exhaust delivery system 110), an electric power output 154, and a fuel cell stack 156.

The air delivery system, as noted, includes the cabin exhaust delivery system 110, which in turn includes a fuel cell inlet line 158 and a fuel cell outlet line 160. The fuel cell inlet line 158 is in fluid communication with the cabin 42 and the fuel cell stack 156 for receiving the cabin exhaust airflow from the cabin 42 and providing such cabin exhaust airflow to the fuel cell stack 156. The fuel cell outlet line 160 is in fluid communication with the fuel cell stack 156 and, as will be explained in more detail below, a fuel tank 48 of an aircraft including the ECS assembly 100 (see, e.g., fuel tank 48 of aircraft 10 of FIG. 1) for receiving a fuel cell exhaust airflow from the fuel cell stack 156 and providing the fuel cell exhaust as an inerting airflow to an interior of the fuel tank 48 to reduce an oxygen content of the interior of the fuel tank 48.

Further, for the embodiment shown, the air delivery system includes an airflow control valve 164 in airflow communication with the fuel cell inlet line 158 for controlling an amount of airflow through the fuel cell inlet line 158 to the fuel cell stack 156. Control of the amount of airflow through the fuel cell inlet line 158 may allow for modulation of one or more operating conditions of the fuel cell assembly 150, as will be discussed in more detail below.

Further, it will be appreciated that for the exemplary embodiment depicted, the fuel cell assembly 150 further includes a humidifier 166 in airflow communication with the fuel cell inlet line 158 and the fuel cell outlet line 160. The humidifier 166 may be configured to extract water from the fuel cell exhaust airflow through the fuel cell outlet line 160 and provide such water to the cabin exhaust airflow through the fuel cell inlet line 158 upstream of the fuel cell stack 156. Depending on a chemistry of the fuel cell stack 156, it may be desirable to have the cabin exhaust airflow provided to the fuel cell stack 156 with a threshold level of humidity.

The fuel delivery system 152 of the fuel cell assembly 150 generally includes a fuel source 168, a fuel delivery line 170, and a fuel valve 172. The fuel source 168 may be any aviation fuel or hydrogen, and in certain exemplary embodiments, the fuel source 168 may be the fuel tank 48 (or may be configured to receive fuel from the fuel tank 48). The fuel delivery line 170 extends from the fuel source 168 to the fuel cell stack 156 and the fuel valve 172 is in fluid communication with the fuel delivery line 170 for modulating an amount of fuel flow through the fuel delivery line 170. Modulation of the fuel valve 172 may allow for modulation of one or more operating conditions of the fuel cell assembly 150, as will also be discussed in more detail below.

The fuel delivery system 152 further includes a fuel exhaust line 174 in fluid communication with fuel cell stack 156 for receiving output products of the fuel cell stack 156.

Although not depicted, the fuel cell assembly 150 may include, e.g., one or more fuel reformers in flow communication with the fuel delivery system 152 for generating a hydrogen rich gas for the fuel cell stack 156.

The electric power output 154 is configured to receive electrical power from the fuel cell stack 156 and generally includes a power controller 176. The power controller 176 may include, e.g., power electronics to convert or condition electrical power received from the fuel cell stack 156. For example, the power controller 176 may include a DC/DC converter to convert the electrical power received to a desired current, voltage, or both.

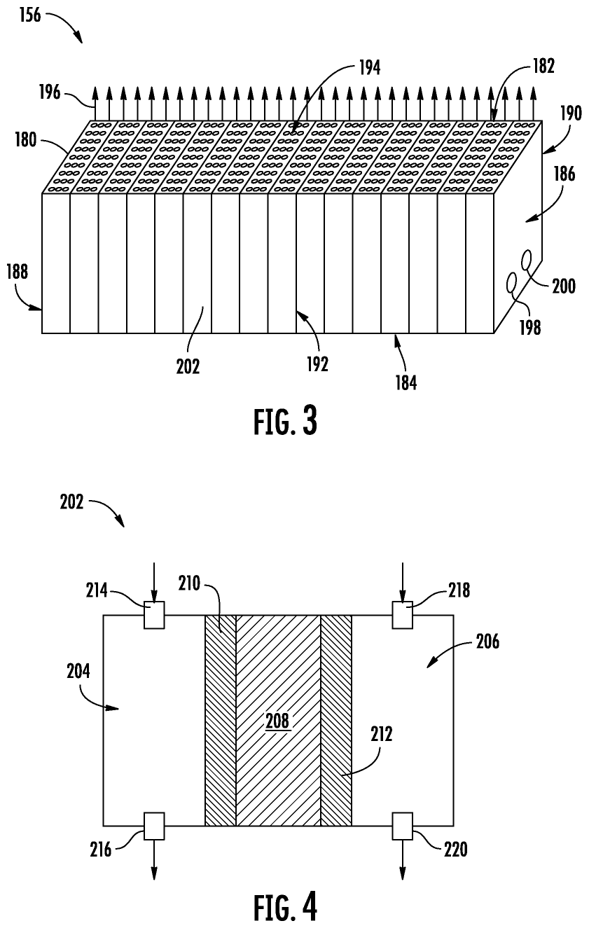

Moreover, referring now to FIG. 3, a schematic illustration is provided as a perspective view of the fuel cell stack 156 of the fuel cell assembly 150 of FIG. 2.

The fuel cell stack 156 depicted includes a housing 180 having an outlet side 182 and a side 184 that is opposite to the outlet side 182, a fuel and air inlet side 186 and a side 188 that is opposite to the fuel and air inlet side 186, and sides 190, 192. The side 190, the side 188, and the side 184 are not visible in the perspective view of FIG. 3.

As will be appreciated, the fuel cell stack 156 may include a plurality of fuel cells 202 that are “stacked,” e.g., side-by-side from one end of the fuel cell stack 156 (e.g., fuel and air inlet side 186) to another end of the fuel cell stack 156 (e.g., side 188). As such, it will further be appreciated that the outlet side 182 includes a plurality of outlets 194, each from a respective fuel cell 202 of the fuel cell stack 156. During operation, output products 196 are directed from the outlets 194 out of the housing 180. As will be appreciated from the description of FIG. 4, below, the outlets 194 include separate fuel outlets (which may be in fluid communication with the fuel exhaust line 174 (see FIG. 2)) and air outlets (which may be in fluid communication with the fuel cell outlet line 160 of the cabin exhaust delivery system 110 (see FIG. 2)).

The fuel and air inlet side 186 includes one or more fuel inlets 198 and one or more air inlets 200. Optionally, one or more of the inlets 198, 200 can be on another side of the housing 180. Each of the one or more fuel inlets 198 is fluidly coupled with the fuel delivery line 170 of the fuel delivery system 152. Each of the one or more air inlets 200 is fluidly coupled with the fuel cell inlet line 158 of the air delivery system.

Referring now to FIG. 4, a close-up, schematic view is provided of a fuel cell 202 of the fuel cell stack 156 of FIG. 3. As will be appreciated, fuel cells are electro-chemical devices which may convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. As a single fuel cell, the fuel cell 202 depicted in FIG. 4 may only be capable of generating on the order of one (1) volt of power. A plurality of fuel cells may be stacked together to form a fuel cell stack, such as the fuel cell stack 156 of FIG. 3, to generate a desired voltage. The exemplary fuel cell 202 depicted in FIG. 4, and each of the fuel cells 202 of the fuel cell stack 156 of FIG. 3, are configured as proton exchange membrane fuel cells (“PEM fuel cells”), also known as a polymer electrolyte membrane fuel cell. PEM fuel cells have an operating temperature range and operating temperature pressure determined to work well with the conditions described herein.

More specifically as is depicted schematically in FIG. 4, the fuel cell 202 generally includes a cathode side 204, an anode side 206, and an electrolyte layer 208 positioned between the cathode side 204 and the anode side 206. The cathode side 204 may generally include a cathode 210 and the anode side 206 and may generally include an anode 212.

The cathode side 204 includes a cathode inlet 214 and a cathode outlet 216 and the anode side 206 includes an anode inlet 218 and an anode outlet 220. The cathode side 204 of the fuel cell 202, and more specifically, the cathode inlet 214 of the cathode side 204 of the fuel cell 202, is in fluid communication with the cabin exhaust delivery system 110, and more specifically, the fuel cell inlet line 158 of the cabin exhaust delivery system 110 of FIG. 2. The cathode outlet 216 is in fluid communication with the fuel cell outlet line 160 of the cabin exhaust delivery system 110. Similarly, the anode side 206 of the fuel cell 202, and more specifically, the anode inlet 218 of the anode side 206 of the fuel cell 202, is in fluid communication with the fuel delivery line 170 of the fuel delivery system 152. The anode outlet 220 is in fluid communication with the fuel exhaust line 174 of the fuel delivery system 152.

Referring now back to FIG. 2, it will be appreciated that during operation of the ECS assembly 100, the ECS assembly 100 may operate the electric motor 118 to compress and condition the ECS airflow using the initial compressor 116 and air cycle machine 114. The ECS assembly 100 may provide the ECS airflow as the cabin inlet airflow to and through the cabin airflow delivery system 108 to the cabin 42 of the aircraft 10, providing for a pressurization and thermal management of the cabin 42 of the aircraft 10.

The ECS assembly 100 may then provide at least a portion of the cabin exhaust airflow to and through the cabin exhaust delivery system 110 to the fuel cell assembly 150. The fuel cell assembly 150 may utilize the cabin exhaust airflow to generate electric power, in combination with fuel flow provided from the fuel delivery system 152. In such a manner, the fuel cell assembly 150 may be integrated with the ECS 102 to efficiently generate electric power. More specifically, instead of the ECS 102 dumping the cabin exhaust airflow to ambient, the cabin exhaust airflow may be utilized in the useful production of electric power using the fuel cell assembly 150.

As briefly mentioned above, the fuel cell stack 156 may include a plurality of PEM fuel cells, such that the fuel cell assembly 150 may be configured as a PEM fuel cell assembly. The cabin exhaust airflow may be at a temperature and pressure particularly desirable for generating electric power using PEM fuel cells and a PEM fuel cell assembly, such as the fuel cell assembly 150 depicted in FIG. 2 (described also with respect FIGS. 3 and 4). In particular, the cabin exhaust airflow may be at a temperature between 60° C. and 90° C., such as between 70° C. and 80° C. Further, a pressure of the cabin exhaust airflow may be between 60 kilopascals and 100 kilopascals such as between 70 kilopascals and 90 kilopascals. These conditions may be desirable for generating electric power using a PEM fuel cell. Accordingly, by utilizing such airflow, the fuel cell assembly 150 need not use excess power to specifically condition an airflow for the fuel cell assembly 150.

Further, referring still to FIG. 2, it will be appreciated that the fuel cell assembly 150 may be configured to generate electric power to sustain operations of the ECS 102 of the ECS assembly 100, without requiring an electric power source outside of the ECS assembly 100.

In particular, for the embodiment depicted, the electric motor 118, which as noted above is configured to drive operations of the ECS assembly 100, defines a maximum power draw. As used herein, the term “maximum power draw” refers to the maximum amount of electric power required for a particular component during all anticipated non-failure mode and non-emergency mode operations for the particular component.

Further, for the embodiment depicted, the fuel cell assembly 150 defines a maximum power rating. As used herein, the term “maximum power rating” refers to a maximum amount of electric power that may be generated during anticipated operating conditions without pre-maturely wearing or degrading the component. For example, the maximum power rating may refer to the maximum amount of power that the fuel cell assembly 150 may generate during a cruise operation of the aircraft 10 within which it is incorporated.

For the exemplary embodiment depicted, the maximum power rating of the fuel cell assembly 150 is higher than the maximum power draw of the electric motor 118. In such a manner, all of the electric power required for operating the ECS 102 may be provided to the ECS 102 from the fuel cell assembly 150. Such may allow for the ECS assembly 100 to be located at a position within the aircraft 10 remote from one or more power sources without requiring relatively heavy, expensive, and complicated electric communication buses.

It will further be appreciated that in at least certain exemplary aspects, depending on how much higher the maximum power rating of the fuel cell assembly 150 is than the maximum power draw, the fuel cell assembly 150 may further be in communication with an electric power bus 222 of the aircraft 10 for providing excess electric power to the electric power bus 222.

Referring still to FIG. 2, it will be appreciated that the ECS assembly 100 further includes a controller 250. The controller 250 is in operable communication with various aspects of the ECS assembly 100 for controlling certain operations of the ECS assembly 100. For example, the ECS assembly 100 may include one or more sensors for sensing various operating conditions. For example, in the embodiment depicted the ECS assembly 100 includes a fuel cell sensor 253 configured to sense data indicative of various operating parameters of the fuel cell assembly 150, such as of the fuel cell stack 156. For example, the fuel cell sensor 253 may be configured to sense data indicative of a temperature of the fuel cell stack 156, a pressure of one or more flows to, through, from, or around the fuel cell stack 156, a gas composition of various flows to, through, from, or around the fuel cell stack 156, etc. In addition, the ECS assembly 100 includes a cabin exhaust airflow sensor 254 configured to sense data indicative of the cabin exhaust airflow through the cabin exhaust delivery system 110, such as, e.g., a flow rate of the cabin exhaust airflow, a pressure of the cabin exhaust airflow, a temperature of the cabin exhaust airflow, a gas composition of the cabin exhaust airflow, etc. Further, still, the ECS assembly 100 includes a cabin sensor 256 for sensing data indicative of an environment within the cabin 42, such as, e.g., a temperature within the cabin 42, a gas composition within the cabin 42, a pressure within the cabin 42, etc. Moreover, in the embodiment depicted, the aircraft including the ECS assembly 100 includes a fuel tank sensor 255 configured to sense data indicative of the fuel tank 48, including, e.g., a gas composition of an air within an ullage of the fuel tank 48.

In the embodiment depicted, the controller 250 is operably coupled to these sensors 253, 254, 255, 256 and various other components of the ECS assembly 100 to control various aspects of the ECS assembly 100. For example, in the embodiment shown, the controller 250 is further in operable communication with the power controller 176 of the fuel cell assembly 150, the electric motor 118 of the ECS 102, the turbine bypass valve 140, the airflow control valve 164, and the fuel valve 172 of the fuel cell assembly 150.

Referring now to FIG. 5, a schematic view is provided of the exemplary controller 250 of the ECS assembly 100 of FIG. 2. As noted, the exemplary controller 250 is configured to receive the data sensed from the one or more sensors (e.g., sensors 253, 254, 255, 256) and, e.g., may make control decisions for the ECS assembly 100 based on the data received from the one or more sensors.

In one or more exemplary embodiments, the controller 250 depicted in FIG. 5 may be a stand-alone controller for the ECS assembly 100, or alternatively, may be integrated into one or more other controllers, such as a controller for an aircraft 10 with which the ECS assembly 100 is integrated (e.g., aircraft controller 50 of FIG. 1), etc.

Referring particularly to the operation of the controller 250, in at least certain embodiments, the controller 250 can include one or more computing device(s) 252. The computing device(s) 252 can include one or more processor(s) 252A and one or more memory device(s) 252B. The one or more processor(s) 252A can include any suitable processing device, such as a microprocessor, microcontroller, integrated circuit, logic device, and/or other suitable processing device. The one or more memory device(s) 252B can include one or more computer-readable media, including, but not limited to, non-transitory computer-readable media, RAM, ROM, hard drives, flash drives, and/or other memory devices.

The one or more memory device(s) 252B can store information accessible by the one or more processor(s) 252A, including computer-readable instructions 252C that can be executed by the one or more processor(s) 252A. The instructions 252C can be any set of instructions that when executed by the one or more processor(s) 252A, cause the one or more processor(s) 252A to perform operations. In some embodiments, the instructions 252C can be executed by the one or more processor(s) 252A to cause the one or more processor(s) 252A to perform operations, such as any of the operations and functions for which the controller 250 and/or the computing device(s) 252 are configured, the operations for operating an ECS assembly 100 and/or fuel cell assembly 150 (e.g., method 600), as described herein, and/or any other operations or functions of the one or more computing device(s) 252. The instructions 252C can be software written in any suitable programming language or can be implemented in hardware. Additionally, and/or alternatively, the instructions 252C can be executed in logically and/or virtually separate threads on the one or more processor(s) 252A. The one or more memory device(s) 252B can further store data 252D that can be accessed by the one or more processor(s) 252A. For example, the data 252D can include data indicative of power flows, data indicative of engine/aircraft 10 operating conditions, and/or any other data and/or information described herein.

The computing device(s) 252 can also include a network interface 252E used to communicate, for example, with the other components of the ECS assembly 100, the aircraft 10 incorporating the ECS assembly 100, a gas turbine engine of the aircraft 10, etc. For example, in the embodiment depicted, as noted above, one or more sensors may be provided for sensing data indicative of one or more parameters of the ECS assembly 100, the fuel cell assembly 150, and/or the fuel tank 48. The controller 250 is operably coupled to the one or more sensors through, e.g., the network interface 252E, such that the controller 250 may receive data indicative of various operating parameters sensed by the one or more sensors during operation. Further, for the embodiment shown the controller 250 is operably coupled to various aspects of the ECS assembly 100 and/or the fuel cell assembly 150 as noted above, e.g., through the network interface 252E. In such a manner, the controller 250 may be configured to control various aspects of the ECS assembly 100 and/or the fuel cell assembly 150 in response to, e.g., the data sensed by the one or more sensors 253, 254, 255, 256.

The network interface 252E can include any suitable components for interfacing with one or more network(s), including for example, transmitters, receivers, ports, controller, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated, however, that the exemplary ECS assembly 100 depicted in FIG. 2 is provided by way of example only. In other exemplary embodiments, the ECS assembly 100, and various aspects of ECS assembly 100, may be configured in any other suitable manner.

Moreover, it will be appreciated that in other exemplary embodiments of the present disclosure, a fuel cell assembly may be incorporated into other aspects of the exemplary aircraft 10 of FIG. 1. For example, in other exemplary embodiments, an aircraft engine of the aircraft 10, such as one or both of the first and second aircraft engines 44, 46 in FIG. 1, may include a fuel cell assembly integrated therein.

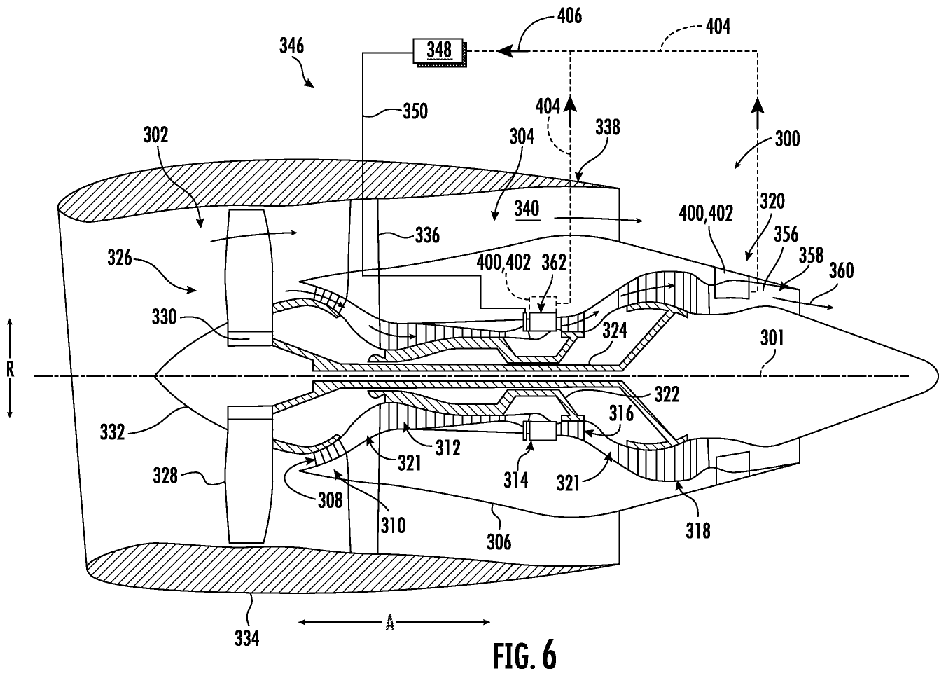

In particular, referring now to FIG. 6, a schematic, cross-sectional view of an engine in accordance with an exemplary embodiment of the present disclosure is provided, with a fuel cell assembly integrated therein. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is a gas turbine engine 300, which is more specifically configured as a high bypass turbofan engine. As shown in FIG. 6, the gas turbine engine 300 defines an axial direction A (extending parallel to a centerline axis 301 provided for reference), a radial direction R, and a circumferential direction (extending about the axial direction A; not depicted in FIG. 6). In general, the gas turbine engine 300 includes a rotor assembly 302 and a turbomachine 304 disposed downstream from the rotor assembly 302.

The exemplary turbomachine 304 depicted generally includes a substantially tubular outer casing 306 that defines an annular inlet 308. The outer casing 306 encases, in serial flow relationship, a compressor section including a booster or low pressure (LP) compressor 310 and a high pressure (HP) compressor 312; a combustion section 314; a turbine section including a high pressure (HP) turbine 316 and a low pressure (LP) turbine 318; and a jet nozzle exhaust section 320. The compressor section, combustion section 314, and turbine section together define at least in part a working gas flowpath 321 extending from the annular inlet 308 to the jet nozzle exhaust section 320. The turbofan engine further includes one or more drive shafts. More specifically, the turbofan engine includes a high pressure (HP) shaft 322 drivingly connecting the HP turbine 316 to the HP compressor 312, and a low pressure (LP) shaft 324 drivingly connecting the LP turbine 318 to the LP compressor 310.

For the embodiment depicted, the rotor assembly 302 includes a fan 326 having a plurality of fan blades 328 coupled to a disk 330 in a spaced apart manner. The plurality of fan blades 328 and disk 330 are together rotatable about the centerline axis 301 by the LP shaft 324. The disk 330 is covered by a rotatable front hub 332 aerodynamically contoured to promote an airflow through the plurality of fan blades 328. Further, an annular fan casing or outer nacelle 334 is provided, circumferentially surrounding the fan 326 and/or at least a portion of the turbomachine 304. The outer nacelle 334 is supported relative to the turbomachine 304 by a plurality of circumferentially-spaced outlet guide vanes 336. A downstream section 338 of the outer nacelle 334 extends over an outer portion of the turbomachine 304 so as to define a bypass airflow passage 340 therebetween.

In such a manner, it will be appreciated that gas turbine engine 300 generally includes a first stream (e.g., working gas flowpath 321) and a second stream (e.g., bypass airflow passage 340) extending parallel to the first stream. In certain exemplary embodiments, the gas turbine engine 300 may further define a third stream extending, e.g., from the LP compressor 310 to the bypass airflow passage 340 or to ambient. With such a configuration, the LP compressor 310 may generally include a first compressor stage configured as a ducted mid-fan and downstream compressor stages. An inlet to the third stream may be positioned between the first compressor stage and the downstream compressor stages.

Moreover, the gas turbine engine 300 depicted is operable with a fuel delivery system 346, which generally includes a fuel source 348, such as a fuel tank, and one or more fuel delivery lines 350. In certain exemplary embodiments, the fuel source 348 may be the fuel tank 48 of the aircraft 10 of FIG. 1.

The one or more fuel delivery lines 350 provide a fuel flow through the fuel delivery system 346 to the combustion section 314 of the turbomachine 304 of the gas turbine engine 300. More specifically, the one or more fuel delivery lines 350 provide a fuel flow through the fuel delivery system 346 to a primary fuel nozzle of the combustion section 314 of the turbomachine 304.

Further, as noted above, the exemplary gas turbine engine 300 includes a fuel cell assembly 400 incorporated therein, such that the fuel cell assembly 400 is configured to receive an inlet airflow from the gas turbine engine 300, and more specifically from the working gas flowpath 321 of the gas turbine engine 300.

In particular, as also noted above, the gas turbine engine 300 includes the jet nozzle exhaust section 320. More specifically, the turbomachine 304 includes an exhaust nozzle 356 located downstream of the turbine section (i.e., downstream of the HP turbine 316 and LP turbine 318 in the embodiment depicted). The exhaust nozzle 356 defines as exhaust gas flowpath 358, through which an exhaust gas flow 360 is directed during operation of the gas turbine engine 300. In addition, as will be described in more detail below, for the embodiment depicted, the fuel cell assembly 400 is positioned within the outer casing 306 of the turbomachine 304 and includes a fuel cell 402 (not separately depicted) positioned aft of a combustor 362 of the combustion section 314. In such a manner, the fuel cell 402 of the fuel cell assembly 400 may be fluidly coupled, thermally coupled, or both to the exhaust gas flowpath 358 during operation of the gas turbine engine 300.

Additionally, or alternatively, the fuel cell assembly 400 may be incorporated into other portions of the gas turbine engine 300, such as the compressor section, the combustion section 314, and/or the turbine section. For example, as is depicted in phantom, the fuel cell assembly 400 may be integrated with the combustor 362. With such a configuration, the fuel cell 402 of the fuel cell assembly 400 may be in thermal communication with combustion gasses within the combustion section 314 and may exhaust fuel to a combustion chamber.

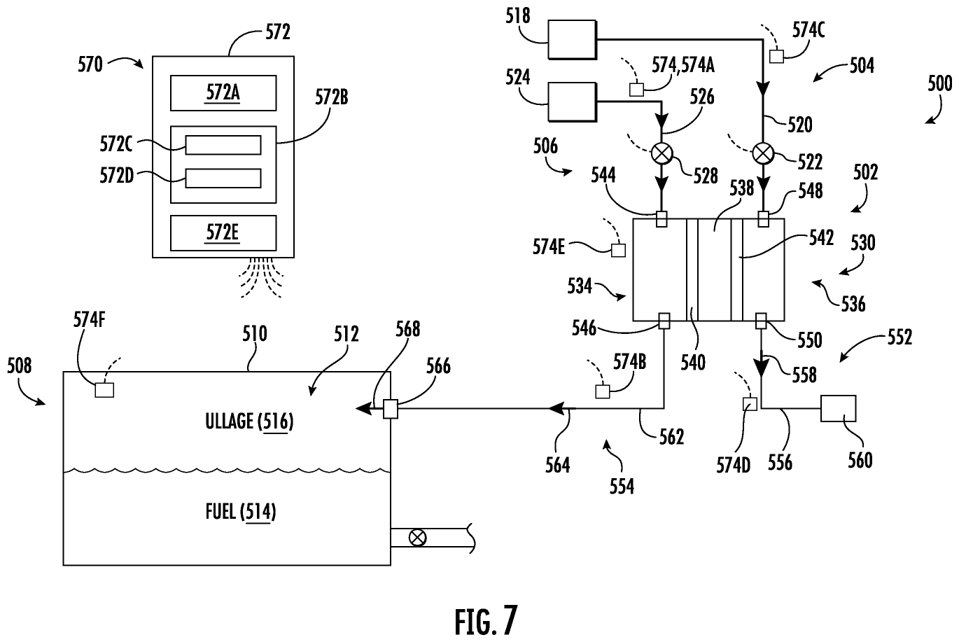

With one or more of these exemplary embodiments, as is depicted in phantom, the fuel cell 402 of the fuel cell assembly 400 may define an air outlet (see cathode outlet 546 of FIG. 7), with the air outlet of the fuel cell 402 in airflow communication with an interior of the fuel tank 348 via airflow lines 404 for providing an inerting airflow 406 from the fuel cell 402 to the interior of the fuel tank 348 to reduce an oxygen content of the interior of the fuel tank 348.

It will be appreciated, however, that the exemplary gas turbine engine 300 depicted in FIG. 6 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine 300 depicted in FIG. 6 is shown schematically as a direct drive, fixed-pitch turbofan engine, in other embodiments, a gas turbine engine of the present disclosure may be a geared gas turbine engine (i.e., including a gearbox between the fan 326 and a shaft driving the fan, such as the LP shaft 324), may be a variable pitch gas turbine engine (i.e., including a fan 326 having a plurality of fan blades 328 rotatable about their respective pitch axes), etc. Moreover, although the exemplary gas turbine engine 300 includes a ducted fan 326, in other exemplary aspects, the gas turbine engine may include an unducted fan 326 (or open rotor fan), without the outer nacelle 334. Further, although not depicted herein, in other embodiments the gas turbine engine may be any other suitable type of gas turbine engine, such as a nautical gas turbine engine.

Referring now to FIG. 7, a system for an aircraft in accordance with another exemplary aspect of the present disclosure is provided. In certain exemplary embodiments, the system of FIG. 7 may be incorporated into the aircraft of FIG. 1, utilizing one or more exemplary aspects of the fuel cell assembly 150 of FIGS. 2 through 5, the fuel cell assembly 400 of FIG. 6, or both.

In particular, for the embodiment of FIG. 7, the system is configured as a fuel tank inerting system 500. The fuel tank inerting system 500 generally includes a fuel cell assembly 502, the fuel cell assembly 502 having a fuel delivery assembly 504, and an airflow delivery assembly 506. The fuel tank inerting system 500 is operable with a fuel tank 508 of an aircraft. In at least certain exemplary embodiments, the fuel tank 508 may be configured in a similar manner as the exemplary fuel tank 48 described above with reference to FIG. 1. In such a manner, it will be appreciated the fuel tank 508 may be positioned at least partially within a wing of an aircraft (see, e.g., fuel tank 48 positioned in wing 22 of aircraft 10 of FIG. 1).

Briefly, the fuel tank 508 generally includes a casing 510 defining an interior 512 and housing a fuel 514. A space above the fuel may be referred to as an ullage 516 of the fuel tank 508.

The fuel delivery assembly 504 generally includes a fuel source 518, a fuel delivery line 520, and a fuel flow valve 522. The fuel source 518 may be, e.g., a hydrogen fuel source. For example, the fuel source 518 may be a hydrogen fuel tank, or may be a fuel processing unit configured to receive aviation fuel and convert the aviation fuel into a hydrogen-rich fuel flow. Further, the fuel flow valve 522 may be configured to modulate a fuel flow through the fuel delivery line 520 to control a fuel flow rate to the fuel cell assembly 502. In such a manner, it will be appreciated that the fuel delivery assembly 504 may operate in a similar manner as the fuel delivery system 152 of the fuel cell assembly 150 described above with reference, e.g., to FIG. 2.

The airflow delivery system 500 generally includes an air source 524, an air delivery line 526, and an airflow valve 528 in fluid communication with the air delivery line 526. In at least certain exemplary aspects, the fuel tank inerting system 500 of FIG. 7 may be integrated with one or more of the exemplary ECS assembly 100 described above with reference to FIGS. 2 through 5, the gas turbine engine 300 described above with reference to FIG. 6, or both. With such exemplary aspect, the airflow delivery system 500 may be configured to receive an airflow from an ECS, from a cabin of the aircraft in which the fuel tank inerting system 500 is incorporated, from a working gas flowpath of a gas turbine engine, or a combination thereof.

Alternatively, however, the airflow delivery system 500 may be configured to receive an airflow from any other suitable air source, such as from an ambient air source, a bypass passage of a gas turbine engine, etc.

The fuel cell assembly 502 generally includes a fuel cell stack, which may include one or more fuel cells 530 (a single fuel cell 530 of the fuel cell stack is depicted in FIG. 7; see, e.g., FIG. 3 for a schematic view of a fuel cell stack).

The fuel cell stack of the fuel cell assembly 502 may be configured in a similar manner as exemplary fuel cell stack described above with reference to FIGS. 2 through 4. In such a manner, it will be appreciated that the exemplary fuel cell stack may be a PEM fuel cell stack positioned within a fuselage of an aircraft.

Additionally, or alternatively, the fuel cell stack of the fuel cell assembly 502 may be configured in a similar manner as exemplary fuel cell assembly 400 described above with reference to FIG. 6. In such a manner, it will be appreciated that the exemplary fuel cell stack may be an SOFC fuel cell stack positioned integrated into a gas turbine engine of an aircraft.

In particular, referring still to FIG. 7, the fuel cell 530 generally includes a cathode side 534, an anode side 536, and an electrolyte layer 538 positioned between the cathode side 534 and the anode side 536. The cathode side 534 may generally include a cathode 540 and the anode side 536 and may generally include an anode 542.

The cathode side 534 includes a cathode inlet 544 and a cathode outlet 546 and the anode side 536 includes an anode inlet 548 and an anode outlet 550. The cathode side 534 of the fuel cell 530, and more specifically, the cathode inlet 544 of the cathode side 534 of the fuel cell 530, is in fluid communication with the airflow delivery assembly 506, and more specifically, the air delivery line 526 of the airflow delivery assembly 506. Similarly, the anode side 536 of the fuel cell 530, and more specifically, the anode inlet 548 of the anode side 536 of the fuel cell 530, is in fluid communication with the fuel delivery line 520 of the fuel delivery assembly 504.

The fuel cell assembly 502 further includes an anode exhaust assembly 552 and a cathode exhaust assembly 554. The anode exhaust assembly 552 includes an anode outlet line 556 and provides an anode exhaust 558 to an anode exhaust sink 560. The anode outlet line 556 extends between the anode outlet 550 and the anode exhaust sink 560 for providing the anode exhaust 558 from the anode outlet 550 to the anode exhaust sink 560.

Further, the cathode exhaust assembly 554 includes a cathode outlet line 562 and provides a cathode exhaust 564 to an inerting gas inlet 566 of the fuel tank 508. The cathode outlet line 562 extends between the cathode outlet 546 and the inerting gas inlet 566 of the fuel tank 508 for providing the cathode exhaust 564 from the cathode outlet 546 to the interior 512 of the fuel tank 508, and more specifically to the ullage 516 of the fuel tank 508 (through the inerting gas inlet 566), as an inerting airflow 568 for reducing an oxygen content of the interior 512 of the fuel tank 508, as will be explained in more detail below.

Referring still to FIG. 7, the exemplary fuel tank inerting system 500 further includes a system controller 570. The system controller 570 may include a similar structure as exemplary controller 250 described above with reference to FIG. 5. For example, the exemplary controller 250 generally includes one or more computing devices 572 having one or more processor(s) 572A and one or more memory device(s) 572B. The one or more memory device(s) 572B can store information accessible by the one or more processor(s) 572A, including computer-readable instructions 572C that can be executed by the one or more processor(s) 572A. The one or more memory device(s) 572B can further store data 572D that can be accessed by the one or more processor(s) 572A. The computing device(s) 572 can also include a network interface 572E.

The system controller 570 of FIG. 7 is operable with various sensors 574 for receiving data indicative of the fuel tank inerting system 500, the fuel tank 508, or both. In particular, for the embodiment depicted, the fuel tank inerting system 500 includes: a first airflow sensor 574A configured to sense data indicative of an airflow through the air delivery line 526 (e.g., an airflow rate, a gas composition of the airflow, a temperature of the airflow, a pressure of the airflow, or a combination thereof); a second airflow sensor 574B configured to sense data indicative of an airflow/cathode exhaust 564 through the cathode outlet line 562 (e.g., an airflow rate, a gas composition of the airflow, a temperature of the airflow, a pressure of the airflow, or a combination thereof); a first fuel sensor 574C configured to sense data indicative of a fuel flow through the fuel delivery line 520 (e.g., a fuel flow rate, a composition of the fuel, a temperature of the fuel, a pressure of the fuel, or a combination thereof); a second fuel sensor 574D configured to sense data indicative of a fuel flow/anode exhaust 558 through the anode outlet line 556 (e.g., a fuel flow rate, a composition of the fuel, a temperature of the fuel, a pressure of the fuel, or a combination thereof); a fuel cell sensor 574E configured to sense data indicative of an operating condition of the fuel cell 530 and fuel cell stack (e.g., a temperature of the fuel cell stack, a pressure within the fuel cell stack, a power output from the fuel cell stack, gas composition data of a flow to, through, from, or around the fuel cell stack, or a combination thereof); and a fuel tank sensor 574F positioned within the interior 512 of the fuel tank 508 for sensing data indicative of the interior 512 of the fuel tank 508 (e.g., a gas composition of the air within the interior 512 of the fuel tank 508, a pressure within the interior 512 of the fuel tank 508, a temperature within the interior 512 of the fuel tank 508, or a combination thereof).

Further, the exemplary system controller 570 is operably connected to various aspects of the fuel tank inerting system 500, and in particular is operably connected to the fuel flow valve 522, the airflow valve 528, and a power controller (not show; see power controller 176 of the fuel cell assembly 150 of FIG. 2). In such a manner, the system controller 570 may receive data from one or more sensors 574 and may make control decisions in response to such received data.

In particular, for the embodiment depicted, the system controller 570 is operably coupled to the fuel cell assembly 502 for controlling an excess air ratio of the fuel cell assembly 502. As used herein, the term “excess air ratio” refers to a ratio of the oxygen provided to the fuel cell assembly 502 to the amount of oxygen that is reacted. For example, the excess air ratio may generally represent a fuel to air ratio of the fuel cell assembly 502 in excess of an optimum fuel to air ratio for the fuel cell assembly 502 to fully utilize the fuel flow provided from the fuel delivery assembly 504 and the airflow provided from the air airflow delivery assembly 506.

In particular, the embodiment depicted, the system controller 570 is operable to maintain the excess air ratio of the fuel cell assembly 502 between 1.2 and 2.05 during operation of the fuel tank inerting system 500, such as between 1.5 and 2.05. More specifically, the system controller 570 is operable to maintain the excess air ratio of the fuel cell assembly 502 to limit and oxygen content of the inerting airflow 568 to less than or equal to 12%.

The inventors of the present disclosure have found that such an operating range may result in a desired power output from the fuel cell assembly 502, while still providing a sufficiently low oxygen content within the inerting airflow 568 provided to the interior 512 of the fuel tank 508.

In such a manner, it will be appreciated that the fuel cell inerting system 500 may be capable of providing the inerting airflow 568 to the interior 512 of the fuel tank 508 from the fuel cell assembly 502 (and fuel cell 530) without any airflow processing to reduce an oxygen content of the cathode exhaust 564 (which is provided as the inerting airflow 568). In particular, it will be appreciated that the fuel cell inerting system 500 is configured such that the cathode exhaust 564 provided from the fuel cell 530 includes a sufficiently low oxygen content (e.g., less than or equal to 12% by weight) to be provided directly to the interior 512 of the fuel tank 508.

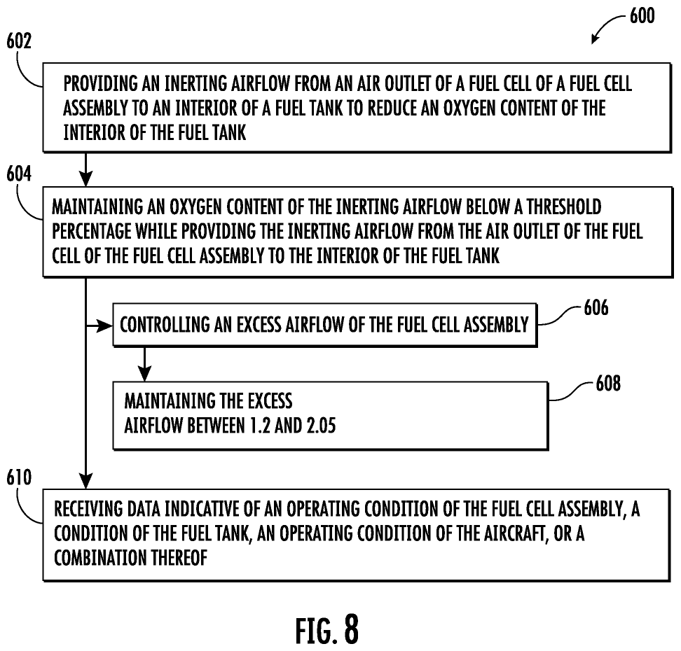

Referring now to FIG. 8, a flow diagram is provided of a method 600 for operating a fuel tank inerting system in accordance with an exemplary aspect of the present disclosure. The method 600 may be utilized with one or more of the exemplary fuel tank inerting systems described above with reference to FIGS. 1 through 7.

The method 600 includes at (602) providing an inerting airflow from an air outlet of a fuel cell of a fuel cell assembly to an interior of a fuel tank to reduce an oxygen content of the interior of the fuel tank.

Additionally, for the exemplary aspect depicted, the method 600 includes at (604) maintaining an oxygen content of the inerting airflow below a threshold percentage while providing the inerting airflow from the air outlet of the fuel cell of the fuel cell assembly to the interior of the fuel tank. The threshold percentage is a percentage at which it is determined there is a sufficiently low likelihood of combustion. In at least certain exemplary aspects, the threshold percentage is 12%.

Moreover, referring still to FIG. 8, in the exemplary aspect depicted, maintaining an oxygen content of the inerting airflow below the threshold percentage at (604) includes at (606) controlling an excess airflow of the fuel cell assembly, and more specifically includes at (608) maintaining the excess airflow between 1.2 and 2.05. In such a manner, the method 600 may prioritize providing an inerting airflow to the fuel tank over operating the fuel cell assembly to produce a maximum amount of electrical power for a given fuel and air flow.

Notably, in at least certain exemplary aspects, the method 600 may further include at (610) receiving data indicative of an operating condition of the fuel cell assembly, a condition of the fuel tank, an operating condition of the aircraft, or a combination thereof. With such an exemplary embodiment, controlling the excess airflow of the fuel cell assembly at (606) may include controlling the excess airflow of the fuel cell assembly in response to the data received at (610).

For example, in one exemplary aspect, receiving data at (610) may include receiving data indicative of an operating condition of the fuel cell assembly. With such an exemplary aspect the data received may indicate the fuel cell is operating at a certain power output or fuel utilization, or that the fuel cell is receiving a certain fuel to air ratio. In response, the method 600 may control an airflow to the fuel cell, a fuel flow to the fuel cell, an electrical power output of the fuel cell, or a combination thereof to control an excess air ratio of the fuel cell assembly and maintain the oxygen content of the inerting airflow below the threshold percentage.

Additionally, or alternatively by way of example, in another exemplary aspect, receiving data at (610) may include receiving data indicative of a condition of the fuel tank. With such an exemplary aspect the data received may indicate that an oxygen percentage of the air within the interior of the fuel tank is above a predetermined threshold (e.g., 12%). In response, the method 600 may control an airflow to the fuel cell, a fuel flow to the fuel cell, an electrical power output of the fuel cell, or a combination thereof to reduce the oxygen content of the inerting airflow below the threshold percentage. Or the data received may indicate that an oxygen percentage of the air within the interior of the fuel tank is below a lower threshold (e.g., less than 10%, less than 8%, or less than 6%). In response, the method 600 may control an airflow to the fuel cell, a fuel flow to the fuel cell, an electrical power output of the fuel cell, or a combination thereof to increase an electrical power output of the fuel cell and reduce an excess air ratio of the fuel cell assembly.

Additionally, or alternatively by way of example, in another exemplary aspect, receiving data at (610) may include receiving data indicative of an operating condition of the aircraft (e.g., a cruise operating condition, an idle operating condition, a descend operating condition). With such an exemplary aspect the data received may indicate that the fuel cell assembly may be operated up to a max excess air ratio while still maintaining an oxygen content of the inerting gas below the threshold percentage. In response, the method 600 may control an airflow to the fuel cell, a fuel flow to the fuel cell, an electrical power output of the fuel cell, or a combination thereof to control the excess air ratio of the fuel cell assembly and maintain the oxygen content of the inerting airflow below the threshold percentage.

In such a manner, it will be appreciated that the method 600 may allow for providing the inerting gas to the interior of the fuel tank from the fuel cell assembly (and fuel cell) without any airflow processing to reduce an oxygen content of the cathode exhaust (which is provided as the inerting gas). In particular, it will be appreciated that the method 600 may include providing the cathode exhaust from the fuel cell directly to the interior of the fuel tank at a sufficiently low oxygen content (e.g., less than or equal to 12% by weight) to function as an inerting airflow.

Further aspects are provided by the subject matter of the following clauses:

A system for an aircraft comprising: a fuel tank defining an interior; and a fuel cell assembly comprising a fuel cell defining an air outlet, wherein the air outlet of the fuel cell is in airflow communication with the interior of the fuel tank for providing an inerting airflow from the fuel cell to the interior of the fuel tank to reduce an oxygen content of the interior of the fuel tank.

The system of the preceding clause, further comprising: an environmental control system; a cabin airflow delivery system in airflow communication with the environmental control system for receiving a cabin inlet airflow from the environmental control system; a cabin exhaust delivery system configured to be in airflow communication with a cabin of the aircraft for receiving a cabin exhaust airflow and providing the cabin exhaust airflow to the fuel cell assembly.

The system of one or more of the preceding clauses, wherein the fuel cell assembly is configured to be positioned in a fuselage of the aircraft.

The system of one or more of the preceding clauses, wherein the fuel cell assembly is a PEM fuel cell assembly.

The system of one or more of the preceding clauses, further comprising: a controller operably coupled to the fuel cell assembly for controlling an excess air ratio of the fuel cell assembly, wherein the controller is operable to maintain the excess air ratio of the fuel cell assembly between 1.2 and 2.05 during operation of the system.

The system of one or more of the preceding clauses, further comprising: a controller operably coupled to the fuel cell assembly for controlling an excess air ratio of the fuel cell assembly, wherein the controller is operable to control the excess air ratio of the fuel cell assembly to limit an oxygen content of the inerting airflow to less than or equal to 12%.

The system of one or more of the preceding clauses, wherein the fuel cell assembly is configured to be incorporated into a gas turbine engine of the aircraft.

The system of one or more of the preceding clauses, wherein the fuel cell assembly is configured to receive an inlet airflow from the gas turbine engine.

The system of one or more of the preceding clauses, wherein the fuel cell assembly is an SOFC fuel cell assembly.

An aircraft comprising: a fuel tank defining an interior; and a fuel cell assembly comprising a fuel cell defining an air outlet, wherein the air outlet of the fuel cell is in airflow communication with the interior of the fuel tank for providing an inerting airflow from the fuel cell to the interior of the fuel tank to reduce an oxygen content of the interior of the fuel tank.

The aircraft of one or more of the preceding clauses, further comprising: a cabin; an environmental control system; a cabin airflow delivery system in airflow communication with the environmental control system for receiving a cabin inlet airflow from the environmental control system; and a cabin exhaust delivery system in airflow communication with the cabin for receiving a cabin exhaust airflow and providing the cabin exhaust airflow to the fuel cell assembly.

The aircraft of one or more of the preceding clauses, wherein the aircraft comprises a fuselage, and wherein the fuel cell assembly is positioned in the fuselage of the aircraft.

The aircraft of one or more of the preceding clauses, wherein the aircraft comprises a gas turbine engine, and wherein the fuel cell assembly is incorporated into the gas turbine engine of the aircraft.

The aircraft of one or more of the preceding clauses, wherein the gas turbine engine defines a working gas flowpath, and wherein the fuel cell assembly is configured to receive an inlet airflow from the working gas flowpath of the gas turbine engine.

A method of operating a system of an aircraft comprising: providing an inerting airflow from an air outlet of a fuel cell of a fuel cell assembly to an interior of a fuel tank to reduce an oxygen content of the interior of the fuel tank.

The method of one or more of the preceding clauses, further comprising: maintaining an oxygen content of the inerting airflow below a threshold percentage while providing the inerting airflow from the air outlet of the fuel cell of the fuel cell assembly to the interior of the fuel tank.

The method of one or more of the preceding clauses, wherein the threshold percentage is 12%.

The method of one or more of the preceding clauses, wherein maintaining the oxygen content of the inerting airflow below the threshold percentage comprises controlling an excess airflow of the fuel cell assembly.

The method of one or more of the preceding clauses, wherein controlling the excess airflow of the fuel cell assembly comprises maintaining the excess airflow between 1.2 and 2.05.

The method of one or more of the preceding clauses, further comprising: receiving data indicative of an operating condition of the fuel cell assembly, a condition of the fuel tank, an operating condition of the aircraft, or a combination thereof; wherein maintaining the oxygen content of the inerting airflow below the threshold percentage comprises controlling the fuel cell assembly in response to the received data.

An aircraft comprising: a body comprising a fuselage and one or more wings, the fuselage defining a cabin; and an environmental control system assembly positioned within the body of the aircraft, the environmental control system assembly comprising: an environmental control system; a cabin airflow delivery system in airflow communication with the environmental control system for receiving a cabin inlet airflow from the environmental control system; a cabin exhaust delivery system configured in airflow communication with the cabin of the aircraft for receiving a cabin exhaust airflow; and a fuel cell assembly in airflow communication with the cabin exhaust delivery system for receiving the cabin exhaust airflow.

The aircraft of any preceding clause, wherein the fuel cell assembly is a polymer exchange membrane fuel cell assembly.

The aircraft of any preceding clause, wherein the fuel cell assembly comprises a fuel cell having an anode and a cathode, and wherein the cathode of the fuel cell is in airflow communication with the cabin exhaust delivery system for receiving the cabin exhaust airflow.

The aircraft of any preceding clause, wherein the environmental control system comprises a compressor, an air cycle machine, and an electric motor drivingly coupled to the compressor and the air cycle machine.

The aircraft of any preceding clause, wherein the electric motor defines a maximum power draw, wherein the fuel cell assembly defines a maximum power rating, and wherein the maximum power rating is higher than the maximum power draw.

The aircraft of any preceding clause, wherein the fuel cell assembly is in electrical communication with the electric motor of the environmental control system for providing electrical power to the electric motor of the environmental control system.

The aircraft of any preceding clause, wherein the environmental control system comprises a compressor and an air cycle machine, and wherein the environmental control system assembly further comprises a mixer, wherein the mixer is in airflow communication with the cabin airflow delivery system, wherein the environmental control system assembly further comprises a recirculation airflow path extending from the cabin to the mixer.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A system for an aircraft comprising:
a fuel tank defining an interior; and
a fuel cell assembly comprising a fuel cell defining an air outlet, wherein the air outlet of the fuel cell is in airflow communication with the interior of the fuel tank for providing an inerting airflow from the fuel cell to the interior of the fuel tank to reduce an oxygen content of the interior of the fuel tank.

2. The system of claim 1, further comprising:
an environmental control system;
a cabin airflow delivery system in airflow communication with the environmental control system for receiving a cabin inlet airflow from the environmental control system; and
a cabin exhaust delivery system configured to be in airflow communication with a cabin of the aircraft for receiving a cabin exhaust airflow and providing the cabin exhaust airflow to the fuel cell assembly.

3. The system of claim 1, wherein the fuel cell assembly is configured to be positioned in a fuselage of the aircraft.

4. The system of claim 1, wherein the fuel cell assembly is a PEM fuel cell assembly.

5. The system of claim 1, further comprising:
a controller operably coupled to the fuel cell assembly for controlling an excess air ratio of the fuel cell assembly, wherein the controller is operable to maintain the excess air ratio of the fuel cell assembly between 1.2 and 2.05 during operation of the system.

6. The system of claim 1, further comprising:
a controller operably coupled to the fuel cell assembly for controlling an excess air ratio of the fuel cell assembly, wherein the controller is operable to control the excess air ratio of the fuel cell assembly to limit an oxygen content of the inerting airflow to less than or equal to 12%.

7. The system of claim 1, wherein the fuel cell assembly is configured to be incorporated into a gas turbine engine of the aircraft.

8. The system of claim 7, wherein the fuel cell assembly is configured to receive an inlet airflow from the gas turbine engine.

9. The system of claim 1, wherein the fuel cell assembly is an SOFC fuel cell assembly.

10. An aircraft comprising:
a fuel tank defining an interior; and
a fuel cell assembly comprising a fuel cell defining an air outlet, wherein the air outlet of the fuel cell is in airflow communication with the interior of the fuel tank for providing an inerting airflow from the fuel cell to the interior of the fuel tank to reduce an oxygen content of the interior of the fuel tank.

11. The aircraft of claim 10, further comprising:
a cabin;
an environmental control system;
a cabin airflow delivery system in airflow communication with the environmental control system for receiving a cabin inlet airflow from the environmental control system; and
a cabin exhaust delivery system in airflow communication with the cabin for receiving a cabin exhaust airflow and providing the cabin exhaust airflow to the fuel cell assembly.

12. The aircraft of claim 10, wherein the aircraft comprises a fuselage, and wherein the fuel cell assembly is positioned in the fuselage of the aircraft.

13. The aircraft of claim 10, wherein the aircraft comprises a gas turbine engine, and wherein the fuel cell assembly is incorporated into the gas turbine engine of the aircraft.

14. The aircraft of claim 13, wherein the gas turbine engine defines a working gas flowpath, and wherein the fuel cell assembly is configured to receive an inlet airflow from the working gas flowpath of the gas turbine engine.

15. A method of operating a system of an aircraft comprising:
providing an inerting airflow from an air outlet of a fuel cell of a fuel cell assembly to an interior of a fuel tank to reduce an oxygen content of the interior of the fuel tank.

16. The method of claim 15, further comprising:
maintaining an oxygen content of the inerting airflow below a threshold percentage while providing the inerting airflow from the air outlet of the fuel cell of the fuel cell assembly to the interior of the fuel tank.

17. The method of claim 16, wherein the threshold percentage is 12%.

18. The method of claim 16, wherein maintaining the oxygen content of the inerting airflow below the threshold percentage comprises controlling an excess airflow of the fuel cell assembly.

19. The method of claim 18, wherein controlling the excess airflow of the fuel cell assembly comprises maintaining the excess airflow between 1.2 and 2.05.

20. The method of claim 16, further comprising:
receiving data indicative of an operating condition of the fuel cell assembly, a condition of the fuel tank, an operating condition of the aircraft, or a combination thereof;
wherein maintaining the oxygen content of the inerting airflow below the threshold percentage comprises controlling the fuel cell assembly in response to the received data.
